(19) United States
(12) Patent Application Publication
(10) Pub. No.: US 2025/0140021 A1
(43) Pub. Date: May 1, 2025

(54) METHOD AND ELECTRONIC DEVICE FOR VIDEO ACTION DETECTION BASED ON END-TO-END FRAMEWORK

(71) Applicants: Versitech Limited, Hong Kong (HK); TCL Technology Group Corporation, Huizhou (CN)

(72) Inventors: Ping LUO, Hong Kong (HK); Shoufa CHEN, Hong Kong (HK); Jiajun SHEN, Hong Kong (HK)

(21) Appl. No.: 18/681,869

(22) PCT Filed: Aug. 19, 2022
(86) PCT No.: PCT/CN2022/113539

§ 371 Date: Feb. 7, 2024

(30) Foreign Application Priority Data
Aug. 23, 2021 (CN) 202110967689.5

(51) Int. Cl. G06V 40/20; G06T 7/70; G06V 10/25; G06V 10/44; G06V 10/764; G06V 10/771; G06V 10/80

(52) U.S. Cl. CPC G06V 40/20; G06T 7/70; G06V 10/25; G06V 10/44; G06V 10/764; G06V 10/771; G06V 10/806; G06V 2201/07

(57) ABSTRACT

The present invention provides a video action detection method and electronic equipment based on an end-to-end framework, which includes a backbone network, a positioning module and a classification module. The method includes: feature extraction of the video clip to be tested by the backbone network, obtaining the video feature map of the video clip, which includes the feature maps of all frames in the video clip; the backbone network extracts the feature map of the key frame from the video feature map and obtains the actor's location features from the feature map of the key frame, and the action category features are obtained from the video feature map; the positioning and classification modules determine the actor's location and action category respectively from the features extracted by the backbone network. This method provided by the present invention has low complexity while achieving better detection performance at the same time.

### FIELD OF THE INVENTION

The present invention relates to the field of video processing technology, and specifically to a video action detection method based on an end-to-end framework and electronic equipment.

### BACKGROUND

Video action detection includes actor bounding box positioning and action classification, and is mainly used in abnormal behavior detection, autonomous driving and other fields. Existing technologies usually utilize two independent stages to achieve video action detection: the first stage uses a target detection model pre-trained on the COCO dataset to be trained on the task dataset to obtain a detector for a single category of actors (such as humans); the second stage uses the detector trained in the first stage to perform actor bounding box positioning (i.e., predict the actor's location), and then extracts the feature map of the actor's location for action classification (i.e., predicts the action category). These two stages use two independent backbone networks. The first stage uses 2D image data to perform actor bounding box localization, and the second stage uses 3D video data to perform action classification.

Using two independent backbone networks to perform actor bounding box positioning tasks and action classification tasks respectively will cause redundant calculations and bring high complexity, thus limiting the application of existing technologies in real-life scenarios. To reduce complexity, using a unified backbone network to replace two independent backbone networks can be considered, however using one backbone network may cause two tasks to interfere with each other. This mutual interference is reflected in the following two aspects: first, the actor bounding box localization task usually uses 2D image models to predict the actor's position in the key frames of the video clip, at this stage, considering adjacent frames in the same video clip will bring additional computing and storage costs as well as localization noise; the second is action classification tasks relying on 3D video models to extract temporal information embedded in video clips, and using single keyframes in actor bounding box localization tasks may lead to poor temporal motion representation for action classification.

### SUMMARY OF THE INVENTION

The purpose of the embodiments of the present invention is to provide a video action detection technology based on an end-to-end framework to solve the problems existing in the above-mentioned existing technologies.

One aspect of the present invention provides a video action detection method based on an end-to-end framework. The end-to-end framework includes a backbone network, a positioning module and a classification module. The video action detection method includes: feature extraction of the video clip to be tested by the backbone network, obtain the video feature map of the video clip to be tested, where the video feature map includes the feature maps of all frames in the video clip to be tested; the backbone network extracts the feature map of the key frame from the video feature map, and obtains from the feature map of the key frame the actor's location features, and the action category features are obtained from the video feature map; the positioning module determines the actor's location based on the actor's location features; and the classification module determines the action category corresponding to the actor's location based on the action category features and the actor's location.

The above method may include: using the backbone network to perform multiple stages of feature extraction on the video clip to be tested to obtain a video feature map for each stage, in which the spatial scales of the video feature maps at different stages are different; using the backbone network to select video feature maps of the last several stages, extract the feature maps of the key frames from the video feature maps of the last several stages, perform feature extraction on the key frames, obtain the actor position features, and the video feature maps from the last of the multiple stages are used as the action category feature. Among them, the residual network can be used to perform multi-stage feature extraction on the video clip to be tested, and the feature pyramid network can be used to extract features from the feature maps of key frames.

In the above method, the key frame can be a frame located in the middle of the video clip to be tested.

In the above method, the classification module determines the action category corresponding to the actor's position based on the action category features and the actor's position, including: the classification module extracts the spatial action features and temporal action features based on the actor's position corresponding to the actor's position, fuse the spatial action features and time action features corresponding to the actor's position, and determine the action category corresponding to the actor's position based on the fused features.

In the above method, the classification module extracts the spatial action features and the temporal action features corresponding to the actor's position from the action category features based on the actor's position, including: the classification module extracts the fixed-scale feature map of the corresponding area from the action category features based on the actor's position; perform a global average pooling operation on the fixed-scale feature map in the time dimension to obtain spatial action features corresponding to the actor's position; and perform a global average pooling operation on the fixed-scale feature map in the spatial dimension operation to obtain the time action characteristics corresponding to the actor's position.

In the above method, the positioning module determines multiple actor positions, and the classification module extracts the spatial action features corresponding to each actor position from the action category features based on each actor position in the multiple actor positions, and temporal action features. The above method may also include: inputting the spatial embedding vectors corresponding to the multiple actor positions into the self-attention module, and performing a convolution operation on the spatial action features corresponding to the multiple actor positions and the output of the self-attention module to update spatial action features corresponding to each of the multiple actor locations; and, inputting the temporal embedding vectors corresponding to the multiple actor locations into the attention module, and inputting the temporal actions corresponding to the multiple actor locations The features are convolved with the output of the self-attention module to update the temporal action features corresponding to each of the multiple actor positions.

In the above method, determining the actor's location includes determining the coordinates of the actor's bounding box and a confidence directing that the actor's bounding box contains the actor. The method may further include: selecting actor locations and corresponding action categories whose confidence is higher than a predetermined threshold.

In the above method, the end-to-end framework is trained based on the following objective function:

$$ℒ = {λ}_{cls} \cdot {ℒ}_{cls} + {λ}_{L 1} \cdot {ℒ}_{L 1} + {λ}_{giou} \cdot {ℒ}_{giou} + {λ}_{act} \cdot {ℒ}_{act}$$

wherein λ_{cls}· [symbol] _{cls}+λ_{L1}· [symbol] _{L1}+λ_{giou}· [symbol] _{giou} represents the actor bounding box localization loss, λ_{act}· [symbol] _{act} represents the action categorization loss, [symbol] _{cls} is the cross entropy loss, [symbol] _{L1} and [symbol] _{giou} are the respective bounding box loss, L is the binary cross entropy loss, λ_{cls}, λ_{L1}, λ_{giou} and λ_{act} are constant scalars used to balance loss contribution.

Another aspect of the present invention provides an electronic device, the electronic device includes a processor and a memory, the memory stores a computer program that can be executed by the processor, the computer program implements the above-mentioned video action detection method video based on the end-to-end framework when executed by the processor.

The technical solutions of the embodiments of the present invention can provide the following beneficial effects:

Using an end-to-end framework, actor locations and corresponding action categories can be directly generated and output from input video clips.

In the end-to-end framework, a unified backbone network is used to simultaneously extract actor location features and action category features, making the feature extraction process more simplified. Among them, in the early stage of the backbone network, the feature map of the key frame (which is used for actor bounding box positioning) and the video feature map (which is used for action classification) have been isolated, reducing the gap between actor bounding box positioning and action classification. mutual interference between them. The positioning module and classification module of the end-to-end framework share the backbone network and do not require additional ImageNet or COCO pre-training.

When performing action classification, the classification module further extracts spatial action features and temporal action features from the action category features, enriching the instance features. In addition, embedding interactions are performed on spatial action features and temporal action features respectively, in which spatial embedding vectors and temporal embedding vectors are used to perform lightweight embedding interactions, which further improves efficiency while obtaining more discriminative features, and improves the performance of action classification.

Experiments show that compared with existing video action detection technology, the video action detection method based on the end-to-end framework provided by the present invention has a lower complexity and simpler detection process, and can also achieve better detection performance.

It should be understood that the foregoing general description and the following detailed description are for purposes of illustration and explanation only, and are not intended to limit the present invention.

### BRIEF DESCRIPTION OF THE DRAWINGS

Exemplary embodiments will be described in detail with reference to the accompanying drawings, which are intended to depict exemplary embodiments and should not be construed as limiting the intended scope of the claims. Unless expressly stated otherwise, the drawings are not deemed to be drawn to scale.

FIG. 1 schematically shows a structural diagram of an end-to-end framework according to an embodiment of the present invention;

FIG. 2 schematically shows a flow chart of a video action detection method according to an embodiment of the present invention;

FIG. 3 schematically shows the structural diagram of a unified backbone network according to an embodiment of the present invention;

FIG. 4 schematically shows a schematic diagram of various operations performed in the classification module according to one embodiment of the present invention.

FIG. 5 schematically shows the structural diagram of an interactive module according to an embodiment of the present invention.

FIG. 6 schematically illustrates a flow chart of a video action detection method based on an end-to-end framework according to an embodiment of the present invention.

### DETAILED DESCRIPTION

In order to make the purpose, technical solutions and advantages of the present invention more obvious, the present invention will be further described in detail below through specific embodiments in conjunction with the accompanying drawings. It should be understood that the specific embodiments described here are only used to explain the present invention and are not intended to limit the present invention.

The block diagrams shown in the figures are functional entities only and do not necessarily correspond to physically separate entities. That is, these functional entities may be implemented in software form, or implemented in one or more hardware modules or integrated circuits, or implemented in different networks and/or processor devices and/or microcontroller devices.

The flowcharts shown in the drawings are only illustrative, and do not necessarily include all contents and operations/steps, nor must they be performed in the order described. For example, some operations/steps can be decomposed, and some operations/steps can be merged or partially merged, so the actual order of execution may change according to the actual situation.

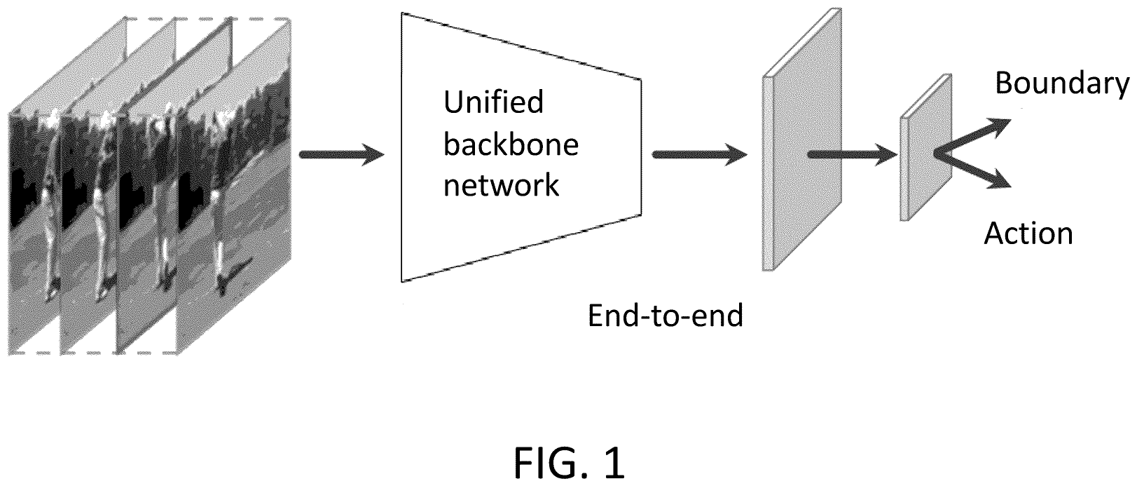

One aspect of the present invention provides a video action detection method, which introduces an end-to-end framework. As shown in FIG. 1, the input of the end-to-end framework is a video clip, and the output is the actor's position and the corresponding action category. The end-to-end framework includes a unified backbone feature extraction network (referred to as the backbone network), which is used to extract actor position features and action category features from input video clips; the end-to-end framework also includes a positioning module and a classification module. The positioning module uses In order to determine the actor's location based on the actor's location characteristics, the classification module is used to determine the action category corresponding to the actor's location based on the action category characteristics and the determined actor's location. The end-to-end framework can directly generate and output actor positions and corresponding action categories from input video clips, making the video action detection process simpler.

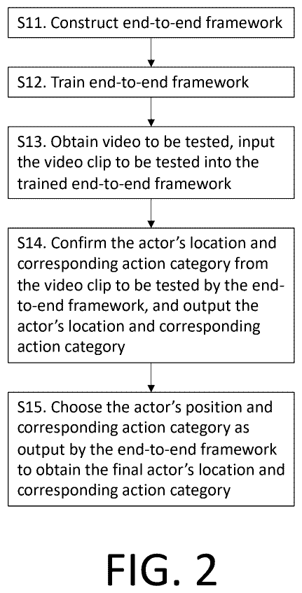

FIG. 2 schematically shows a flow chart of a video action detection method according to an embodiment of the present invention. In summary, the method includes constructing and training an end-to-end framework, and using the trained end-to-end framework to extract data from the video to be tested. Determine the actor's position and corresponding action category in the clip. Each step of the video action detection method will be described below with reference to FIG. 2.

Step S11. Build an end-to-end framework.

Overall, the end-to-end framework includes a unified backbone network, positioning module, and classification module.

The unified backbone network consists of a residual network (ResNet) containing multiple stages (for example, 5 stages) and a Feature Pyramid Network (FPN) containing multiple layers (for example, 4 layers). The backbone network receives Video clips (which may be preprocessed video clips, for example) are input to the end-to-end framework, and actor location features and action category features are output. Within the backbone network, ResNet performs multiple stages of feature extraction on the input video clips to obtain the video feature map of each stage (or the video feature map extracted at each stage). The video feature maps of different stages are The spatial scales are different. The video feature map consists of the feature maps of all frames in the video clip and can be expressed as X∈^{C×T×H×W}, where C represents the number of channels, T represents time (it also represents the number of frames in the input video clip), and H and W represent the spatial height and width respectively. Within the backbone network, after obtaining the video feature maps of each stage of ResNet, the feature maps of key frames in the video feature maps extracted in the subsequent stages of ResNet (for example, the last 4 stages) are extracted as the input of FPN, FPN extracts features from the feature maps of key frames to obtain actor position features; in addition, the video feature map extracted in the last stage of ResNet is used as the action category feature of the actor. Among them, the key frame refers to the frame located in the middle of the input video clip, such as the frame located at └T/2┘ of the video clip, the feature map of the key frame can be expressed as X_{t=└T/2┘}∈^{C×H×W}.

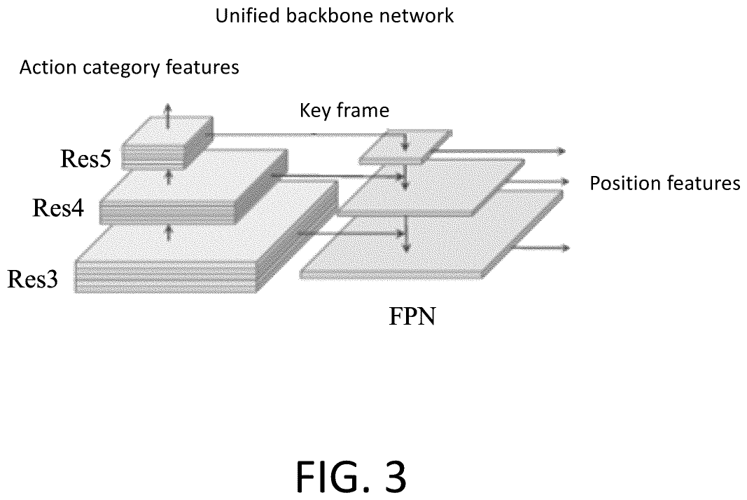

FIG. 3 schematically shows the structural diagram of the backbone network composed of ResNet and FPN, where ResNet contains 5 stages Res1-Res5 (the first two stages are not shown in the figures) and FPN contains 3 layers. As shown in FIG. 3, for the feature maps of key frames in the video feature maps extracted in the Res3-Res5 stage, FPN performs further feature extraction to obtain actor position features; in addition, the video feature maps extracted in the Res5 stage also Treated as action category features. In this embodiment, the backbone network is described as consisting of ResNet containing multiple stages and a feature pyramid network containing multiple layers, but it should be understood that the backbone network can also adopt a network including only one stage or one layer to perform feature extraction.

The positioning module is used to perform actor bounding box positioning. Its input is the actor position feature (output from the backbone network), and the output is the actor position. The output actor position may include the coordinates of the actor's bounding box (referred to as the bounding box) and the corresponding score, where the bounding box refers to the bounding box containing the actor, and its coordinates indicate the actor's position in the video clip (more Specifically, the position in the key frame), the score indicates the confidence that the corresponding bounding box contains the actor, and the higher the confidence, the greater the probability that the corresponding bounding box contains the actor. It should be noted that the number of actor positions (i.e., the number of bounding boxes) output by the positioning module each time is fixed and can be one or more. This number should be greater than or equal to the number of all actors in the key frame. For the convenience of description, N is used to represent the number of actor positions in the following text, and N is set to an integer greater than 1.

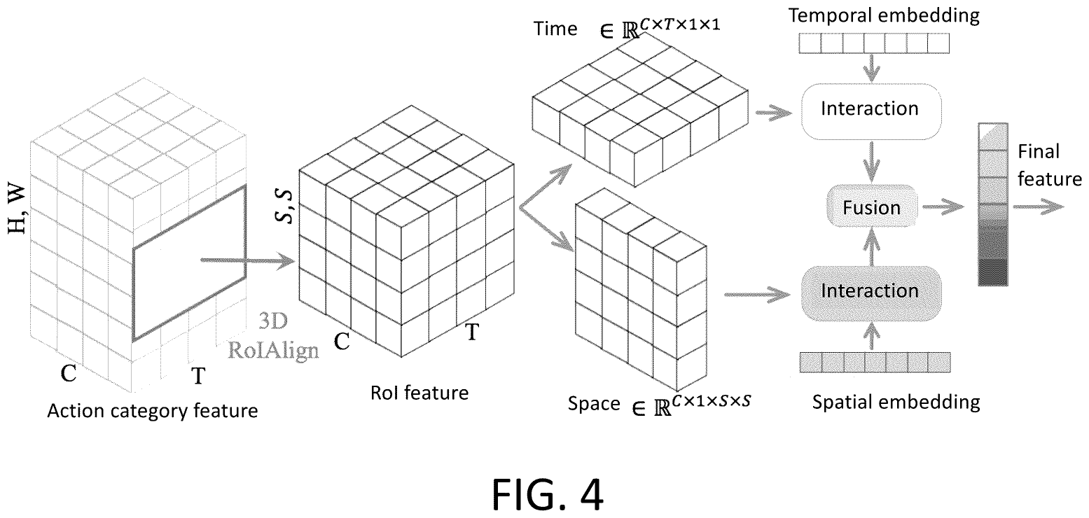

The classification module is used to perform action classification. Its input is the action category feature (output by the backbone network) (that is, the video feature map extracted by the last stage of ResNet) and N actor positions (output by the positioning module), and outputs is the action category corresponding to each actor position. Specifically, the classification module, on the basis of N actor positions (corresponding to N bounding boxes), extracts spatial action features and temporal action features from action category features for each actor position to obtain the spatial action features and temporal action features each actor position; fuse the final spatial action features and the final temporal action features of each actor's position to obtain the final action category features corresponding to each actor's position; and determine the action category corresponding to the actor's location according to the final action category features corresponding to each actor's position. Referring to FIG. 4 below, each operation performed in the classification module is described separately:

1. Based on the N actor positions (i.e., N bounding boxes) determined by the positioning module, spatial action features and temporal action features are extracted from action category features for each position.

As mentioned above, the input of the classification module is the video feature map of the last stage of ResNet in the backbone network X₁ ∈^{C×T×H×W} (action category feature), where I represents the total number of stages of ResNet. According to the N actor positions determined by the positioning module, more specifically, according to the coordinates of the N bounding boxes, extract the fixed-scale feature map of the corresponding area in X₁∈^{C×T×H×W} through RoIAlign, where S×S is the output spatial scale of RoIAlign, thereby obtaining the RoI features corresponding to each of the N actor positions. Perform a global average pooling operation on the RoI features corresponding to each actor's position in the time dimension to obtain the spatial action features of each actor's position f₁^{s}, f₂^{s}, f₃^{s}, . . . , f_{N}^{s}∈^{C×1×S×S}, where fₙ^{s} denotes the spatial action feature of the position of the nth actor and 1≤n≤N; perform a global average pooling operation on the RoI features corresponding to each actor's position in the spatial dimension to obtain the temporal action features of each actor's position f₁^{t}, f₂^{t}, f₃^{t}, . . . , f_{N}^{t}∈^{C×T×1×1}, where fₙ^{t} denotes the temporal action feature of the position of the nth actor.

In addition to the above methods, the spatial action features and temporal action features of each actor position can also be extracted in the following ways: perform global average pooling operation on action category features X₁∈^{C×T×H×W} in the time dimension to obtain spatial feature mapping f^{s}∈^{C×1×H×W}; according to the N actor positions determined by the positioning module, the fixed-size feature map of the corresponding area is extracted in fs through RoIAlign, and the spatial action characteristics of each position in the N actor positions f₁^{s}, f₂^{s}, f₃^{s}, . . . , f_{N}^{s}∈^{C×1×S×S} are obtained; perform a global average pooling operation on the action category features X₁∈^{C×T×H×W} in the spatial dimension to efficiently extract the temporal action features of each position in N actor positions f₁^{t}, f₂^{t}, f₃^{t}, . . . , f_{N}^{t}∈^{C×T×1×1}.

2. Perform embedding interactions on the spatial action features and temporal action features of the N actor positions respectively to obtain the final spatial action features and final temporal action features of each of the N actor positions.

The spatial action features of each actor position are set with corresponding spatial embedding vectors, and the temporal action features of each actor position also have corresponding temporal embedding vectors. Among them, the spatial embedding vector is used to encode spatial attributes, such as shape, posture, etc., and the temporal embedding vector is used to encode temporal dynamic attributes, such as the dynamics and time scale of actions, etc.

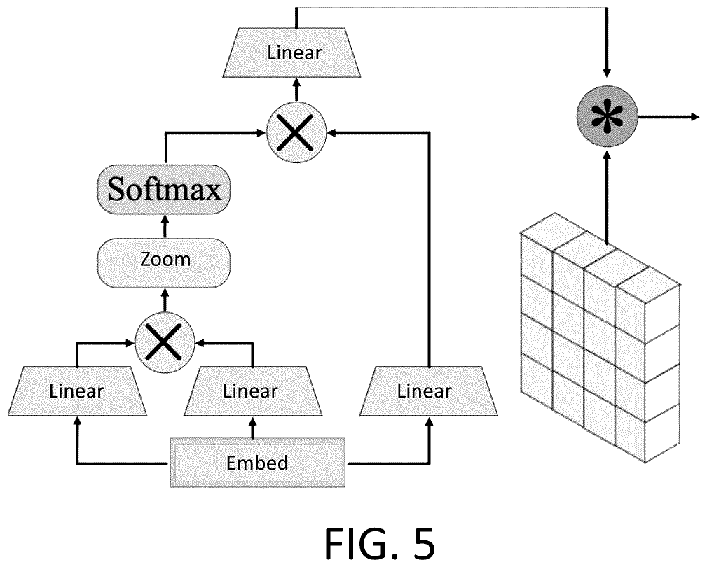

Input the spatial embedding vectors and spatial action features corresponding to N actor positions into the interaction module shown in FIG. 5, where FIG. 5 shows the self-attention module included in the interaction module (shown in the left half of FIG. 5) and convolution operations (shown in the right half of FIG. 5). The spatial embedding vectors corresponding to the N actor positions obtain the corresponding output through the self-attention module. The corresponding output is convolved with the spatial action features of the N actor positions using a 1*1 convolution operation, thus obtaining N The final spatial action characteristics for each of the actor positions. Similarly, the time embedding vectors and time action features corresponding to the N actor positions are input into the interaction module shown in FIG. 5, and the final time action features of each actor position among the N actor positions are obtained.

In order to capture the relationship information between different actors, a self-attention mechanism is introduced here to obtain richer information, and further, the spatial embedding vectors and temporal embedding vectors corresponding to the spatial action features and temporal action features of each actor position are applied to the self-attention mechanism, and then the output results of the self-attention module are convolved with spatial action features and temporal action features to obtain more discriminative features. Compared with directly integrating spatial action features and temporal action features Compared with applying the self-attention mechanism, lighter spatial embedding vectors and temporal embedding vectors can improve efficiency.

3. Fusion of the final spatial action features and the final temporal action features of each of the N actor positions to obtain the final action category features corresponding to each actor position. Among them, fusion operations include but are not limited to sum operations, splicing operations, cross-attention, etc.

4. Determine the action category corresponding to each actor position based on the final action category features corresponding to the position. The fully connected (FC) layer can be used to identify the position from the final action category features corresponding to each actor position. The corresponding action category, which indicates the probability value for each of all action categories.

The above describes an end-to-end framework (the input is a video clip and the output is the actor position and the corresponding action category). In this end-to-end framework, a unified backbone network is used to simultaneously extract actor position features and Action category features simplify the feature extraction process. In addition, the feature maps of key frames and video feature maps have been isolated in the early stages of the backbone network, reducing the mutual interference between actor bounding box positioning and action classification.

In order to train the end-to-end framework, the objective function is further constructed as follows:

$$ℒ = {\underbrace{{λ}_{cls} \cdot {ℒ}_{cls} + {λ}_{L 1} \cdot {ℒ}_{L 1} + {λ}_{giou} \cdot {ℒ}_{giou}}}_{Actor positioning loss} + {\underbrace{{λ}_{act} \cdot {ℒ}_{act}}}_{Action categorization loss} \qquad ( 1 )$$

The objective function consists of two parts: one part is the actor localization loss, where represents the cross-entropy loss on two categories (including actors and not containing actors), and represents the bounding box loss respectively, and represents the balancing loss. A constant scalar that contributes; the other part is the action classification loss, where represents the binary cross-entropy loss for action classification and represents a constant scalar used to balance the loss contribution.

Step S12. Train the end-to-end framework.

During the training phase, a training dataset is obtained to perform end-on-end training on the framework. Among them, the Hungarian algorithm is used to perform bipartite graph matching between the coordinates of the N bounding boxes output by the end-to-end framework (more specifically, the positioning module in the end-to-end framework) and the actor's true position to find an optimal match. For the bounding box that matches the true position, the actor localization loss is calculated according to formula (1) and the action classification loss is further calculated, based on the two (more specifically, based on the sum of the two), reverse gradient propagation is performed to update the parameters; for bounding boxes that do not match the true position, only the actor positioning loss is calculated according to formula (1), and the action classification loss is not calculated for reverse gradient propagation and parameter update. Bipartite graph matching is used to train the positioning module. The positioning module does not need to perform post-processing operations such as non-maximum suppression (NMS).

It should be understood that after the training set is completed, the test data set can also be used to evaluate the accuracy of the final end-to-end framework.

Step S13. Obtain the video clip to be tested and input the video clip to be tested into the trained end-to-end framework. You can first preprocess the video clips to be tested, and then input the preprocessed video clips to be tested into the trained end-to-end framework.

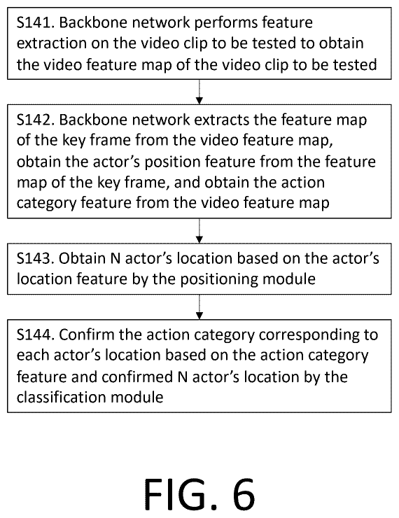

Step S14. The end-to-end framework determines the actor's position and corresponding action category from the video clip to be tested, and outputs the actor's position and corresponding action category. Referring to FIG. 6, step S14 includes the following sub-steps:

S141. The backbone network in the end-to-end framework performs feature extraction on the video clip to be tested, and obtains the video feature map of the video clip to be tested. The video feature map includes the feature maps of all frames in the video clip to be tested.

The backbone network consists of ResNet containing multiple stages and FPN containing multiple layers. Within the backbone network, ResNet performs multiple stages of feature extraction on the video clip to be tested, thereby obtaining the video feature map of each stage. Among them, the spatial scales of video feature maps at different stages are different.

S142. The backbone network in the end-to-end framework extracts the feature map of the key frame from the video feature map, obtains the actor position feature from the feature map of the key frame, and obtains the action category feature from the video feature map.

After obtaining the video feature maps of each stage of ResNet, the feature maps of the key frames in the video feature maps extracted in the subsequent stages of ResNet are extracted as the input of FPN, and FPN performs feature extraction on the feature maps of the key frames. Thus, the actor location characteristics are obtained. Among them, the key frame refers to the frame located in the middle of the video clip to be tested.

In addition, the video feature map extracted in the last stage of ResNet is used as the action category feature of the actor.

S143. The positioning module in the end-to-end framework determines N actor locations based on the actor location characteristics. Among them, the input of the positioning module is the actor position characteristics, and the output is N actor positions. The output actor position can include the coordinates of the actor's bounding box, which refers to the bounding box containing the actor, and its coordinates indicate the actor's position in the video clip (more specifically, in the keyframe position), the score indicates the confidence that the corresponding bounding box contains the actor. The higher the confidence, the greater the probability that the corresponding bounding box contains the actor.

S144. The classification module in the end-to-end framework determines the action category corresponding to each actor position based on the action category characteristics and the determined N actor positions.

Based on the N actor positions, the classification module first extracts spatial action features and temporal action features from the action category features for each actor position, and obtains the spatial action features and temporal action features of each actor position; then, embedding interactions are performed on the spatial action features and temporal action features of multiple actor positions respectively, and the final spatial action features and final temporal action features of each position in the multiple actor positions are obtained. The classification module also fuses the final spatial action features and the final temporal action features of each actor's position to obtain the final action category features corresponding to each actor's position; based on the final action category features corresponding to each actor's position, determine the action category corresponding to the actor's position.

Step S15. Select the actor position and corresponding action category output by the end-to-end framework to obtain the final actor position and corresponding action category.

As mentioned above, the N actor positions output by the end-to-end framework include the coordinates of the N actor bounding boxes and the corresponding scores (i.e., confidence), from which the confidence is greater than a predetermined threshold (e.g., the threshold is 0.7) is selected. Actor position and corresponding action category as the final result.

The above embodiment adopts an end-to-end framework, which can directly generate and output actor positions and corresponding action categories from input video clips. In the end-to-end framework, a unified backbone network is used to simultaneously extract actor location features and action category features, making the feature extraction process more simplified. Among them, in the early stage of the backbone network, the feature map of the key frame (which is used for actor bounding box positioning) and the video feature map (which is used for action classification) have been isolated, reducing the gap between actor bounding box positioning and action classification. mutual interference between them. The positioning module and classification module of the end-to-end framework share the backbone network and do not require additional ImageNet or COCO pre-training.

In the above embodiment, the positioning module uses the bipartite graph matching method for training, and there is no need to perform post-processing operations such as non-maximum suppression during the evaluation phase. When performing action classification, the classification module further extracts spatial action features and temporal action features from the action category features, enriching the instance features. In addition, embedding interactions are performed on spatial action features and temporal action features respectively, in which spatial embedding vectors and temporal embedding vectors are used to perform lightweight embedding interactions, which further improves efficiency while obtaining more discriminative features. and improved action classification performance.

In order to verify the effectiveness of the embodiments of the present invention, the detection performance of the video action detection method provided by the present invention was compared with other existing video action detection technologies. Table 1 shows the comparison results. The data in Table 1 are obtained by training and testing on the AVA data set. It can be seen that compared with other existing technologies, the video action detection method provided by the present invention can significantly reduce the computational requirements, is less complex and simpler, and the detection performance index mAP is better.

TABLE 1

| | Computational | | | |
|---|---|---|---|---|
| Method | requirements | End-to-end | Pre-training | mAP |
| AVA | — | x | K400 | 15.6 |
| SlowFast, R50 | 223.3 | x | K400 | 24.7 |
| Present | 141.6 | ✓ | K400 | 25.2 |
| invention, R50 | | | | |
| SlowFast, R101 | 302.3 | x | K600 | 27.4 |
| Present | 251.7 | ✓ | K600 | 28.3 |
| invention, R101 | | | | |

Another aspect of the present invention provides a schematic structural diagram of a computer system suitable for implementing an electronic device according to an embodiment of the present invention. A computer system may include: a bus coupled to the bus for rapid transmission of information between devices; a processor coupled to the bus and configured to perform a set of actions or operations specified by a computer program, the processor may be alone or in conjunction with Other device combinations are implemented as mechanical, electrical, magnetic, optical, quantum or chemical components, etc.

The computer system may also include a memory coupled to the bus, and the memory (eg, RAM or other dynamic storage device) stores data that can be changed by the computer system, including instructions or computer programs that implement the video motion detection method described in the above embodiments. When the processor executes the instruction or computer program, the computer system is enabled to implement the video action detection method described in the above embodiments. For example, each step shown in FIG. 2 and FIG. 6 can be implemented. Memory can also store temporary data generated during the execution of instructions or computer programs by the processor, as well as various programs and data required for system operation. The computer system also includes read-only memory coupled to the bus and non-volatile storage devices, such as magnetic or optical disks, for storing data that persists when the computer system is turned off or powered off.

Computer systems may also include input devices such as keyboards, sensors, and the like, and output devices such as cathode ray tubes (CRTs), liquid crystal displays (LCDs), printers, and the like. The computer system may also include a communication interface coupled to the bus, which may provide one-way or two-way communication coupling to external devices. For example, the communication interface may be a parallel port, serial port, telephone modem, or local area network (LAN) card. The computer system may also include drive devices coupled to the bus as well as removable devices, such as magnetic disks, optical disks, magneto-optical disks, semiconductor memories, etc., which are mounted on the drive devices as needed to facilitate computer programs read therefrom as needed. is installed into the storage device.

It should be understood that although the present invention has been described through preferred embodiments, the present invention is not limited to the embodiments described here, and also includes various changes and changes made without departing from the scope of the present invention.

1. A video action detection method based on an end-to-end framework, wherein the end-to-end framework includes a backbone network, a positioning module and a classification module, wherein the method comprises:
performing feature extraction on the video clip to be tested with the backbone framework to obtain a video feature map of the video clip to be tested, where the video feature map includes feature maps of all frames in the video clip to be tested;
extracting feature maps of key frames from the video feature maps with the backbone network, obtains actor position features from the feature maps of the key frames, and obtains action category features from the video feature maps;
determining the actor's location based on the actor's location characteristics with the positioning module; and
determining the action category corresponding to the actor's location based on the action category characteristics and the actor's location with the classification module.

2. The method according to claim 1, wherein the method comprises:
performing multiple stages of feature extraction on the video clip to be tested with the backbone network to obtain video feature maps at each stage, wherein the spatial scales of the video feature maps at different stages are different;
selecting the video feature maps of the last several stages among the multiple stages with the backbone network, extracting the feature maps of the key frames from the video feature maps of the last several stages, performing feature extraction on the feature maps of the key frames to obtain the actor position feature, and using the video feature map of the last stage among multiple stages as the action category feature.

3. The method according to claim 2, wherein a residual network is used to perform multiple stages of feature extraction on the video clip to be tested, and a feature pyramid network is used to perform feature extraction on the feature map of the key frame.

4. The method according to claim 1, wherein the key frame is a frame located in the middle of the video segment to be tested.

5. The method according to claim 1, wherein determining, by the classification module, the action category corresponding to the actor position according to the action category characteristics and the actor position includes:
extracting the spatial action features and the temporal action features corresponding to the actor's position from the action category features based on the actor's position with the classification module, fusing the spatial action features and temporal action features corresponding to the actor's position, and determining the action category corresponding to the actor's position based on the fused features.

6. The method according to claim 5, wherein extracting by the classification module based on the actor's position, extracting the spatial action features and the temporal action features corresponding to the actor's position from the action category features includes:
extracting a fixed-scale feature map of the corresponding area from the action category features based on the actor's position with the classification module; performing a global average pooling operation on the fixed-scale feature map in the time dimension to obtain the spatial action characteristics corresponding to the actor's position; and performing a global average pooling operation on the fixed-scale feature map in the spatial dimension to obtain the temporal action characteristics corresponding to the actor's position.

7. The method of claim 5, wherein a plurality of actor locations are determined by the positioning module, and the action category is determined by the classification module based on each actor location of the plurality of actor locations, extracting spatial action features and temporal action features corresponding to each actor's position from the features; and, the method further includes:
inputting the spatial embedding vectors corresponding to the multiple actor positions into the self-attention module, and performing a convolution operation on the spatial action features corresponding to the multiple actor positions and the output of the self-attention module to update spatial action characteristics corresponding to each of the plurality of actor positions; and
inputting the temporal embedding vectors corresponding to the multiple actor positions into the self-attention module, perform a convolution operation on the temporal action features corresponding to the multiple actor positions and the output of the self-attention module, to update temporal action features corresponding to each of the plurality of actor locations.

8. The method according to claim 1, wherein determining the actor location includes determining coordinates of an actor's bounding box and a confidence indicating that the actor's bounding box contains the actor; and, the method further include:
selecting an actor location with a confidence level higher than a predetermined threshold and an action category corresponding to the actor location.

9. The method according to claim 8, wherein the end-to-end framework is trained based on the following objective function:
$$ℒ = {λ}_{cls} \cdot {ℒ}_{cls} + {λ}_{L 1} \cdot {ℒ}_{L 1} + {λ}_{giou} \cdot {ℒ}_{giou} + {λ}_{act} \cdot {ℒ}_{act}$$
wherein λ_{cls}· [symbol] _{cls}+λ_{L1}· [symbol] _{L1}+λ_{giou}· [symbol] _{giou} represents the actor bounding box localization loss, λ_{act}· [symbol] _{act} represents the action categorization loss, [symbol] _{cls} is the cross entropy loss, [symbol] _{L1} and [symbol] _{giou} are the respective bounding box loss, [symbol] _{act} is the binary cross entropy loss, and λ_{cls}, λ_{L1}, λ_{giou} and λ_{act} are constant scalars used to balance loss contribution.

10. An electronic device, wherein the electronic device includes a processor and a memory, the memory stores a computer program that can be executed by the processor, and when executed by the processor, the computer program implements the method according to claim 1.
